(19) United States
(12) Patent Application Publication
(10) Pub. No.: US 2015/0074775 A1
(43) Pub. Date: Mar. 12, 2015

(54) System and Method To Enhance Personal Server Security Using Personal Server Owner's Location Data

(71) Applicant: Pradeep Nambiar, Austin, TX (US)

(72) Inventor: Pradeep Nambiar, Austin, TX (US)

(21) Appl. No.: 14/476,763

(22) Filed: Sep. 4, 2014

Related U.S. Application Data
(60) Provisional application No. 61/874,374, filed on Sep. 6, 2013.

(51) Int. Cl. H04L 29/06; H04W 4/02; G06F 21/60; H04W 48/04

(52) U.S. Cl. CPC H04L 63/0823; H04W 48/04; H04W 4/021; G06F 21/60
USPC 726/5; 726/10

(57) ABSTRACT

A system and method to enhance Personal Server Security using Personal Server owner's location data as derived from the Personal Server owner's mobile client computer by controlling certain aspects of the Personal Server security application and Personal Server applications for example automatically or manually disabling access to certain Personal Server applications from the Wide Area Network (Internet) based on if the Personal Server owner is at the home premises and therefore can access the Personal Server from within the trusted Local Area Network and at other times selectively enabling access to certain Personal Server applications from the Wide Area Network when the Personal Server owner is away from the home premises and the only means of accessing such application while away from the premises is via the Wide Area Network.

### CROSS REFERENCE TO RELATED APPLICATION

This application is based on provisional application Ser. No. 61/874,374, filed on Sep. 6, 2013.

### STATEMENT REGARDING FEDERALLY SPONSORED RESEARCH OR DEVELOPMENT

Not Applicable

### DESCRIPTION OF ATTACHED APPENDIX

Not Applicable

### FIELD OF INVENTION

The present invention generally relates to the field of computer security for personal computing server system and more specifically to a system and method to enhance personal server security using personal server owner's location data.

### BACKGROUND OF THE INVENTION

Personal Computing became popular in the 1980s with the advent of Personal Computers (PCs). During the 1980's, people used PCs for a number of things such as gaming, document creation, word processing, printing document and storing personal data. The personal data remained on the Personal Computer and was backed up using floppies or other external storage medium. PCs were not connected and personal data privacy was not an issue.

With the advent of networking; PCs became connected with other PCs and limited data sharing started between PCs. External networks were created through gateway computers that let PCs talk to other PCs outside a Local Area Network. All data sharing was between systems and usually between trusted parties. Once the data was transferred to other PCs via network, the users slowly lost control of their data. Data on other PCs and systems started to be defined by a different set of terms that are beyond the control of the original user that owned the data.

1990's saw the advent of Internet and Web technologies where PCs started to talk to computer systems from far flung locations. Web technologies introduced software applications that could reside on remote servers and could be accessible to number of users simultaneously. More and more people started to use the PC to connect to the Internet and Web Applications and people started to lose further control of their personal data as their personal data was stored on remote servers. Once the data leaves the PC, the data is managed by the owner of remote servers and policies of the application service providers. PCs soon started to become just a device to access and manage personal data stored on remote servers.

2000's introduced free web based electronic mail services offered by number of companies that lured many to share their personal electronic mail exchanges with companies that would scan mail messages to serve advertisements. Securing privacy and confidentiality to personal data became challenging. Surveillance of personal data exchanged through third party remote servers raised concern on the privacy and confidentiality of personal data.

Today Personal Computing focuses on personal computer desktops and laptops that requires interaction and are being only used to access data or share data through a remote server owned by a separate entity or an application service provider. Applications are owned and managed by third parties. Currently users have a number of personal applications to manage personal data, but this data sits on remote computer servers where the user doesn't have direct control of their data. Data privacy is also not guaranteed as number of other entities may have access to the personal data through data sharing terms that the users may not even be aware of. The remote computer server also hosts data for millions or billions of users. A single security breach makes the personal data of all the users vulnerable. Decentralizing the personal data from remote computer servers into private computer servers called Personal Server (PS); which are placed in the premises of the personal server owner will reduce the risk of such vulnerability to personal data. Users can also have complete control of their data and can share or use the data on their own terms.

Despite advances in computer security computer servers are still vulnerable to sustained attacks that can exploit known vulnerabilities in a computer server. The greater the amount of time a server is exposed to the Wide Area Network (Internet) greater is the risk of being attacked from the internet. Third party remote servers are used by number of different users and hence the access to applications on remote servers needs to be available at all times. Personal servers only serve the personal server owner or a limited set of users authorized by the personal server owner. This enables controlling access to personal servers much easier. Personal servers can be setup to access from multiple networks for example it can be setup to be accessed from Wide Area Network and also Local Area Network. The duration of access can be controlled based on personal server owner's preference.

Some applications on personal servers rely on the personal server being connected to the internet at all times. While other applications only serve the personal server owner and need not be connected to the internet at all times but available only to the Local Area Network or Wide Area Network based on how and when the personal server owner would access such application. The personal server owner can access the personal server applications from the Wide Area Network (Internet) when the personal server owner is away from residential or office premises where the personal server computer is physically located. When in close proximity of the personal server, the personal server owner can access the personal server using the trusted private Local Area Network instead of less trusted Wide Area Network. Applications that doesn't rely on being connected to the Wide Area Network when the personal server owner can access the personal server application from within the trusted Local Area Network can be disabled until such time the personal server owner is away from the personal server location and outside the reach of the Local Area Network. In such cases the personal server applications can be enabled to have access from the Wide Area Network. Selectively disabling applications from the Wide Area Network during the period when the personal server owner is at his premises and therefore can access the personal server from Local Area Network; will greatly enhance the security of the personal server by reducing the time the personal server and personal server applications are exposed to less trusted Wide Area Network (Internet).

This invention provides system and method to enhance the personal server security using the location data generated from the GPS (Global Positioning System) from a client computer such as laptop, smart phone and other forms of client computing device that is mobile and in possession and also owned by the Personal Server owner.

### BRIEF SUMMARY OF THE INVENTION

The invention generally relates to a system related with personal server security; the system includes Personal Server (8.10), Personal Server Security Application (8.20), Personal Server Owner's Mobile Device (8.30), Network Router (8.40), Local Area Network (8.50), External IP Address (8.60), Internal IP Address (8.70), Security Client Application (8.80), Personal Server Applications (8.90), Security Client Key And Certificate (8.100), Personal Server Security Application Key (8.110), Personal Server Operating System (8.120), Mobile Device Operating System (8.130), Wide Area Network (internet) (8.140), Domain Name Service (8.150)

There has thus been outlined, rather broadly, some of the features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object is to provide a System and Method to enhance Personal Server security using Personal Server owner's location data derived from the Personal Server owner's mobile device also called client computer that is equipped with a global positioning system (GPS) or other means of determining the location of the client computer and hence the location of the Personal Server owner at any given time.

Another object is to provide a System and Method to enhance Personal Server Security using Personal Server Owner's location data from the Personal Server owner's mobile computing device by securely sending the location information to the Personal Server automatically to disable Personal Server application access from Wide Area Network (Internet) when the owner is inside or in close proximity to location of the Personal Server where the Personal Server owner can access the Personal Server using the Local Area Network.

Another object is to provide a System and Method to enhance Personal Server Security using Personal Server Owner's location data from the Personal Server owner's mobile computing device by securely sending the location information to the Personal Server automatically to enable Personal Server application access from the Wide Area Network (Internet) when the owner is away from the local premises where the Personal Server cannot access the Personal Server using the Local Area Network

Another object is to provide a System and Method to enhance Personal Server Security using the Personal Server owner's mobile computing device by securely sending commands to the Personal Server manually or on demand to enable or disable the Personal Server applications access from the less trusted Wide Area Network (Internet) when the owner is away from the vicinity of local premises where Personal Server is located.

Another object is to provide a System and Method to enhance Personal Server Security using Personal Server Owner's location data using a pre-loaded security key and certificate on the Personal Server Owner's mobile application to securely authenticate to the Personal Server when communicating to the Personal Server.

Another object is to provide a System and Method to enhance Personal Server Security using Personal Server Owner's last location data as additional authentication data to enhance the authenticity of the request from Wide Area Network for Personal Server applications.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

Various other objects, features and advantages of the present invention will become fully appreciated as the same becomes better understood when considered in conjunction with the accompanying drawings.

NOTE: Figures use the (N.MMM) format follows the convention where ‘N’ denotes the Figure number to easily locate a referencing item in a Figure. For example—Personal Server (1.110) refers to the Personal Server element marked 1.110 in FIG. 1.

FIG. 1: FIG. 1 is an upper perspective view of the present invention. FIG. 1 depicts the interconnection and communications between the Personal Server and Personal Server Owner's mobile device from the Wide Area Network (1.140) and the Local Area Network (1.170) and how access can be enabled and disabled depending on the location of the Personal Server Owner's Mobile device (1.130). The figure shows the home (1.120) of the Personal Server Owner (1.160) where the Personal Server (1.110) is located. The Personal Server (1.110) is connected to the Wide Area Network (Internet) (1.140) using a Network Router (1.150). The Network Router (1.150) also provides Local Area Network (1.170) connectivity within the home or within close proximity of the home. The access to the Personal Server (1.110) from the Local Area Network is more trusted as the Personal Server Owner (1.160) has a known number of trusted devices connected to the Local Area Network (1.170) when compared with access from the Wide Area Network (Internet) (1.140) which consists of un-trusted devices and users. The Personal Server Owner (1.160) also uses a mobile device (1.130) such as a smart phone, tablet or similar device to communicate to the Personal Server (1.110) via the internet when the Personal Server Owner (1.160) is away from home. When the Personal Server Owner (1.160) is within his home or in close proximity to his home they can connect to Personal Server (1.110) using Local Area Network. Personal Server Owner's mobile device also has the capability for determining the location of the mobile device (1.130) and hence the location of the Personal Server owner (1.160) at any given time. A client application referred to as Personal Server Client Security application can communicate the location of the Personal Server Owner (1.160) to the Security Application running on Personal Server (1.110) to disable access from the Wide Area Network when the Personal Server Owner is in close proximity of the home or inside the home. When the Personal Server owner is away from home, the Personal Server Security Application will direct the Personal Server to enable access from the Wide Area Network (Internet) (1.140) automatically or manually. Another variation of home could be an office environment.

FIG. 2: FIG. 2 is a block diagram illustrating sub-components of a mobile client computer, as sub-system of the present invention. FIG. 2 depicts a block diagram of a mobile device (1.130) for accessing the Personal Server (1.110). A mobile device could be a smart phone, tablet, laptop computer or similar device that can be carried by the Personal Server Owner when away from home and that has the capability to detect the location coordinate of the device and hence the location of the Personal Server Owner (1.160). Personal Server Owner's Mobile device (1.130) may include components such as a memory (2.230), a processor (2.220), a bus (2.210) which connects the various components of the mobile device, an Input/Output (I/O) controller (2.240) that controls the input and output including display, touch based input or a keyboard device (2.270). The mobile device also includes a network interface (2.260) that can connect to the internet and Personal Server (1.110). The Personal Server Owner's mobile device may also include Global Positioning System (GPS) component that can get the location of the mobile device or it may have other means to determine the location of the mobile device based on Internet Protocol address of the current connection to the internet or other software means of finding the location of the mobile device.

FIG. 3: FIG. 3 is a block diagram illustrating the sub-components of Personal Server one of the sub-system the present invention. FIG. 3 depicts a block diagram of Personal Server (1.110) components. A Personal Server is a mini computer that is designed to run continuously. It is connected to the home or office Local Area Network using a network interface. The Personal Server (1.110 includes a processor (3.320), memory (3.330), an I/O controller (3.340), a mass storage device (3.350) for storing instructions for the operating system and applications and data (3 350), a networking interface (3.360), a bus (3.310) that connects the various components and facilitates data transfer and control.

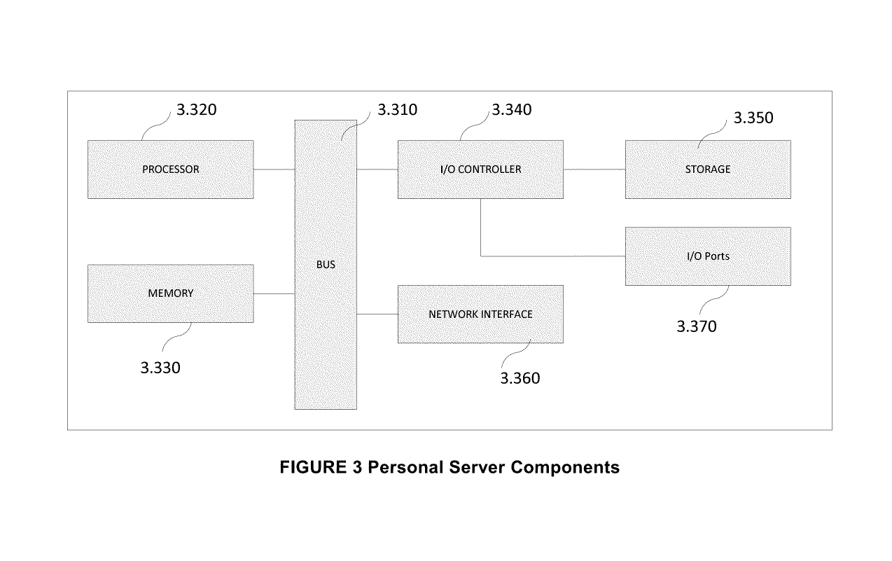

FIG. 4: FIG. 4 is a flowchart illustrating a method of the present invention. FIG. 4 depicts the flow chart for Personal Server Client Security application related with this invention that runs on the Personal Server Owner's mobile client computer device (1.130). The client security application is setup using the flow chart as shown in FIG. 7. Once setup all communication between the client security application and the Personal Server (1.110) will use the client certificate based authentication to securely communicate to Personal Server Security application. The client security application is enabled (4.410) for location data, before authenticating with the Personal Server Security Application (4.420). A session token is created by Personal Server Security Application that is used to send the location data to Personal Server Security Application (4.430) at pre-defined interval (4.440). Personal Server Security Application will enable or disable access to Personal Server applications from Wide Area Network (Internet) access based on the location data. If the session token is expired (4.450), the mobile device will re-authenticate to create a new session token. This location data can also be used to control other aspects of the Personal Server security application and other personal server applications to provide location based services personalized to the location of the personal server owner and users authorized by the personal server owner.

FIG. 5: FIG. 5 is a flowchart illustrating a sub-operation of the present invention. FIG. 5 depicts the flow chart for Personal Server Security Client Application on-demand or manual override mode where the Personal Server Owner (1.160) can send a command from the Mobile device (1.130) to Personal Server Security Application to allow or disallow internet access manually. The first step to send the command manually is to authenticate with Personal Server (1.110) using security certificate stored on the mobile device (5.510). Once authenticated a session token is returned to the Personal Server Owner's Mobile device (1.130) the session token is used for subsequent communication to the Personal Server security application. The Personal Server Security Client Application sends Enable or Disable command (5.520) to the Personal Server Security application. A success or failure is returned from Personal Server Security Application. On success the Personal Server owner can exit (5.550) or choose to send another command (5.520). On command failure the Personal Server Owner can exit from the security client or choose to send another command (5.520). Additional commands to control other aspects of the personal server security application or personal server applications can also be sent with the location data for additional location based services personalized to the personal server owner or users authorized by the personal server owner.

FIG. 6: FIG. 6 is a flowchart illustrating a sub-operation of the present invention. FIG. 6 depicts the flow chart for the Personal Server Security Application. The Personal Server Security application accepts request (6.610) from the Personal Server Security Client Application from Personal Server Owner's Mobile Device (1.130). If the request is an authentication request and the authentication is successful (6.621), then the Personal Server Security Application creates a session token and responds with the session token to the Personal Server Security Client Application running on Personal Server Owner's mobile device. If the authentication is unsuccessful, then an error response (6.630) is provided to the Personal Server Security Client Application. If the request received is location data command (6.622), and then check if the location data is outside the Personal Server Owner's home or office location (6.623). If the location data is outside the home or office location, then enable Personal Server Applications from Internet access (6.660). If the location data indicates it is Personal Server Owner's home or location or in close proximity of the location of Personal Server, then disables Personal Server applications from Internet access (6.650). The next step in the process is to respond with the command status (6.670) and continue listening for next request. If the request is Override Enable Access command (6.624), then enable Personal Server Applications from Internet access (6.660), or else disable Personal Server Applications from Internet access (6.650). The next step in the process is to respond with the command status (6.670) and continue listening (6.610) to the next request from Personal Server Security Client Application from Personal Server Owner's mobile device (1.130).

FIG. 7: FIG. 7 is a flowchart illustrating a method of the present invention. FIG. 7 depicts the flow chart for setting up the Personal Server Security Client Application installed on Personal Server Owner's Mobile device (1.130). The Personal Server Security Application and the Personal Server Security Client Application running on Personal Server Owner's Mobile device communicate with encrypted data using asymmetric key encryption mechanism. To facilitate this secure communication, the Personal Server Security Client Application installed on the Personal Server Owner's mobile device needs to store the client security key and certificate by downloading this key and certificate in a secure way. The security client application installed on Personal Server Owner's Mobile device (1.130), connects to the Personal Server (1.110) using the Personal Server Administrator user ID and password (7.710). The connection for setup is only allowed from the Local Area Network and is not open from the Wide Area Network (Internet). The Personal Server Security Application generates a client and server security key pair (7.720). The Personal Server Security Client Application downloads the client security key and certificate (7.730). The Personal Server Security Application registers the Personal Server Owner's mobile device and associates the key pair with the mobile device (7.740). The Personal Server Security Client Application disconnects (7.750) and configures to communicate with Personal Server Security Application securely using the client and server key encryption mechanism.

FIG. 8: FIG. 8 is a block diagram illustrating the main elements and sub-elements of the present invention.

Personal Server (8.10) consists of hardware components—Processor (8.11), Memory (8.12), Bus (8.13), I/O Controller (8.17), Storage (8.15), I/O Ports (8.16), and Network Interface (8.14). Personal Server (8.10) run an operating system (8.120) that loads and manages Personal Server Applications (8.90) and Personal Server Security Application (8.20) as it relates to this invention. Personal Server also hosts the Security Key (8.110) that is used to decrypt the secure communication from the Personal Server 337 Security Client Application (8.80) running on the Personal Server Owner's Mobile Device (8.30).

Personal Server Owner's Mobile device (8.30) can communicate with the Personal Server (8.10) over the Wide Area Network (Internet) (8.140) when the Personal Server Owner is away from the home location of the Personal Server, and it can also communicate with Personal Server on the Local Area Network (8.50) using an internal hostname or domain name or Internal IP Address (8.70) when the Personal Server Owner's Mobile Device (8.30) and hence the Personal Server Owner is within the range of the Local Area Network (8.50). When the Personal Server Security Client Application (8.80) is resolving connections to the Personal Server (8.10) from the Wide Area Network (Internet) (8.140), it may resolve the Personal Server using a hostname and domain name that is associated with the External IP address (8.60) of the of the internet service for the premises and routed to the Personal Server with the Local Area Network router. The host name and domain name resolution is done by Domain Name System (DNS) Servers. The DNS Servers receive the association via the Domain Name Service (8.150). The Domain Name Service is subscribed by the Personal Server Owner. Alternatively the in the absence of the Domain Name Service, the Personal Server can also be accessed by the external IP address of the internet service for the premises directly.

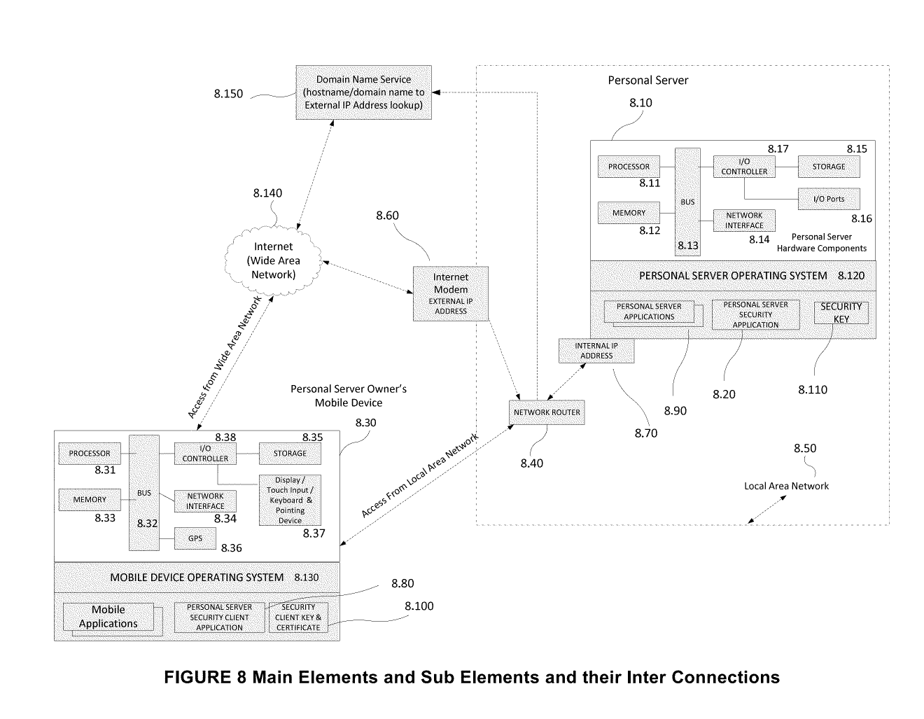

FIG. 8 also shows the sub-components of the Personal Server Owner's Mobile device (8.30) that includes Processor (8.31), Bus (8.32), Memory (8.33), I/O Controller (8.38), Storage (8.35), Network Interface (8.34), GPS (8.36), and Display/Touch Input/Keyboard & Pointing Device (8.37). Personal Server Owner's Mobile Device also runs Mobile Device Operating System (8.130) that manages the entire hardware components, Mobile Applications and Personal Server Security Client Application (8.80).

[symbol]

### DETAILED DESCRIPTION OF EMBODIMENTS

### Overview

This present invention is a method and system for enhancing the Personal Server Security based on the Personal Server Owner's location in relation to location of the Personal Server (8.10) and Local Area Network (8.50). The location of the Personal Server Owner is deduced from the Personal Server Owner's Mobile Device (8.30) such as smart phone, tablet or laptop computer that the Personal Server Owner keeps in their possession.

The system comprising of the Personal Server (8.10) can be used in a home or office environment. A Personal Server (8.10) is a computing server that is designed to manage the personal data and personal automation tasks and runs continuously even when the Personal Server Owner is not in the vicinity of the Personal Server. Unlike a Personal Computer that requires a display monitor and input devices such as mouse and keyboard and constant interaction while seated near the Personal Computer, a Personal Server does not require a display monitor or input devices. It is connected to the Local Area Network (8.50) at home or in an office environment. When the Personal Server Owner is in the vicinity of the Personal Server, it can use a mobile device such as smart phone, tablet or laptop device that can connect to the Personal Server remotely over a Local Area Network or when the Personal Server Owner is away from the reach of the Local Area Network (8.40), it can access the Personal Server over a Wide Area Network (Internet) (8.140). A Local Area Network (8.40) is more trusted and secure as it consists of computing devices that are trusted and usually owned by the Personal Server Owner. A Wide Area Network (Internet) (8.140) is considered less trusted and less secure as it is a network of computers where not all computing devices are trusted. Malicious users can send request to Personal Server and install malicious code that can compromise the Personal Server data.

This invention provides the system and method to reduce the time the Personal Server is exposed to the internet by tracking the location of the Personal Server Owner via the Personal Server Owner's Mobile Device and to disable access from to certain Personal Server applications from the Wide Area Network (Internet) (8.140) when the Personal Server Owner is known to be in the vicinity of the Personal Server (8.10) and can therefore access the Personal Server via the trusted Local Area Network (8.50). When accessing from the trusted Local Area Network (8.50), Personal Server Applications can be disabled from access from the Wide Area Network (Internet). (8.140)

### Operation of Preferred Embodiment

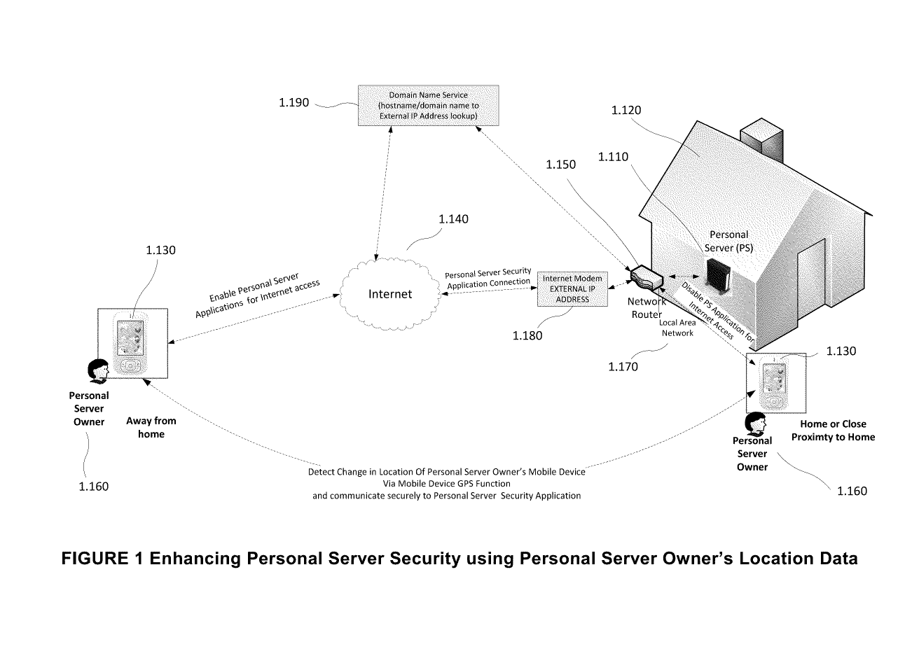

FIG. 1 shows the high level overview of this invention. The main elements for this invention comprises of a Personal Server (1.110), Personal Server Owner's Mobile Device (1.130), Local Area Network (1.170), Internet (1.140) and the Personal Server Security Client Application (8.80) running on the Personal Server Owner's Mobile Device (1.130) and the Personal Server Security Application (8.20) on the Personal Server (1.110)

The Personal Server Security Application (8.20) installed on the Personal Server (8.10) receives the Personal Server Owner's location data sent by the Personal Server Security Client Application (8.80) installed on the Personal Server Owner's Mobile Device (1.130). It shuts off access to the Personal Server applications over the Wide Area Network (Internet) (1.140) when it detects the Personal Server Owner is able to access the Personal Server (1.110) using the Local Area Network (1.140). It enables access over the Wide Area Network (8.140) when it detects the Personal Server Owner is outside the Local Area Network (8.50) coverage. The Personal Server owner can also override the automatic behavior by overriding the access control manually.

### Personal Server

Enhancing the Personal Server security is a key element of this invention. The Personal Server is accessed via the network using client devices such as a smart phone, tablet, laptop or desktop computer. It is setup to be accessed over the Local Area Network (8.50) or over Wide Area Network (Internet) (8.140). The Personal Server (8.10) runs an operating system and applications that manages the Personal Server Owner's data and personal automation tasks.

### Personal Server Owner's Mobile Device

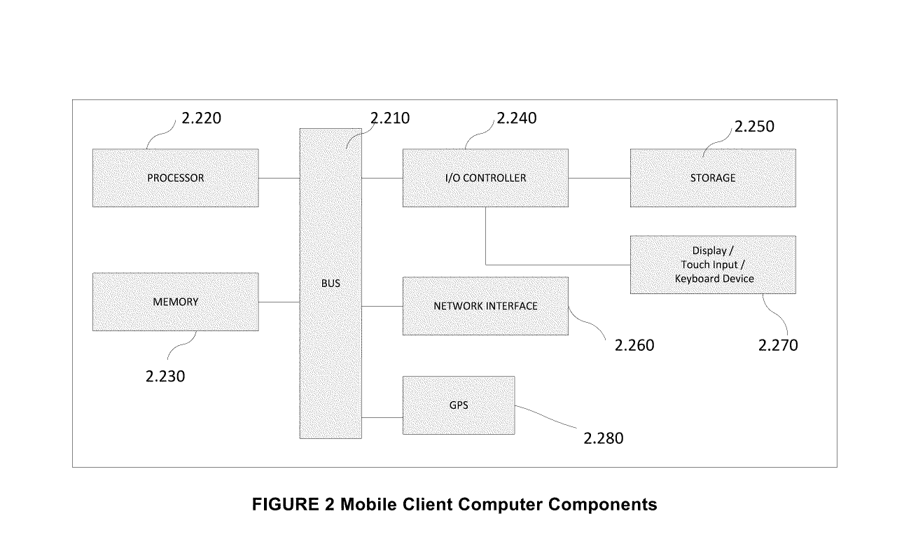

FIG. 2 depicts the key sub-components of the Personal Server Owner's Mobile Device (8.30). Personal Server Owner's Mobile Device (8.30) may be a smart phone, tablet or a portable computer such as a laptop. The mobile device as shown in FIG. 2 has a processor (2.220), memory (2.230), a bus (2.210) that interconnects the various components within the mobile device, an Input Output Controller (2.240), storage (2.250) that is used to store the operating system, application code, System Data and Personal Server Owner's data, a display and input component (2.270). This invention uses the location data obtained from the GPS (global Positioning System) component (2.280) within the mobile device that can receive the location data or via other software services that provides the location data to the mobile device.

Overview of relationship between Main Elements and Sub-Elements

FIG. 8 provides a detailed component diagram for main elements and sub-elements used for this invention.

This invention provides a system and method to enhance the Personal Server Security by automatically or manually disabling the access from less trusted and less secure Wide Area Network (Internet) (8.140) when the Personal Server determines the Personal Server Owner is within the domain of the Local Area Network (8.50). The Personal Server Owner's location is periodically read by the Personal Server Security application (8.20). The location data is sent to the Personal Server Security Application (8.20) securely by the Personal Server Security Client Application (8.80) running on the Personal Server Owner's Mobile device (8.30).

Client Applications accessing Personal Server Applications (8.90) can connect using both the External IP address (and external hostname) (8.60) and Internal IP address (or internal hostname) (8.70). When access via External IP address (8.60) (or external hostname) is disabled, the client applications can only connect to the Personal Server Applications (8.90) using the internal IP address (or internal hostname) (8.70) only.

### Personal Server Security Application and Security Client Application Setup

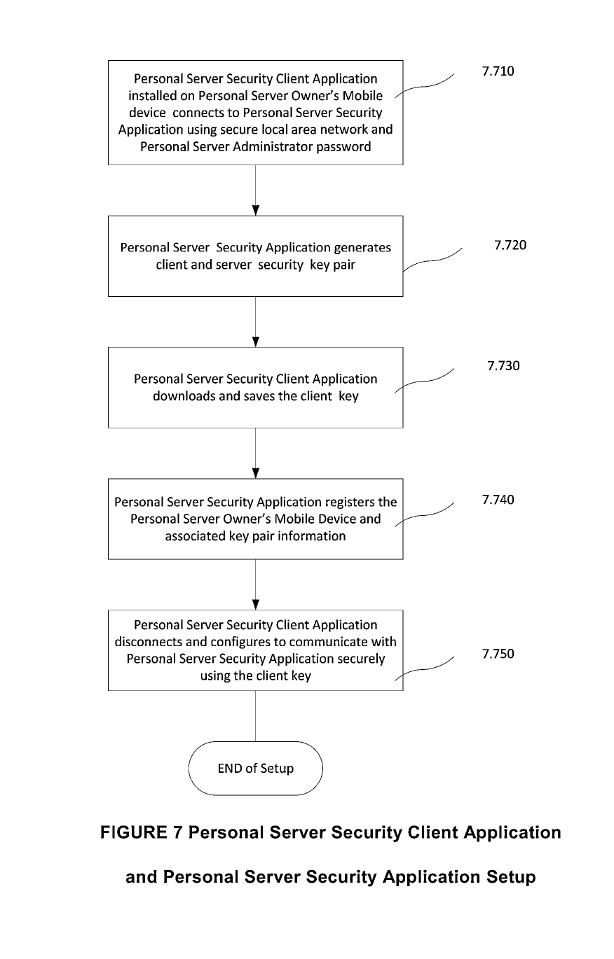

Personal Server Security Client Application (8.80) running on the Personal Server Owner's Mobile Device (8.30) is configured and paired with the Personal Server Security Application (8.20) running on the Personal Server. FIG. 7 depicts the flow chart for setting up the Personal Server Security Client Application (8.80) installed on Personal Server Owner's mobile device (1.130). The Personal Server Security Application (8.20) and the Personal Server Security Client Application (8.80) on Personal Server Owner's Mobile Device (8.30) communicate with encrypted data using asymmetric key encryption mechanism. To facilitate this secure communication, the security client application installed on the Personal Server Owner's mobile device needs to store the client security key and certificate by downloading this key and certificate in a secure way. The Personal Server Security Client Application installed on Personal Server Owner's Mobile device (8.30), connects to the Personal Server (8.10) using the Personal Server Administrator user ID and password. Refer FIG. 7, where it is shown the first step for setup is to connect to the Personal Server using Administrator user ID and password (7.710). To ensure security, the setup connection is only allowed from the Local Area Network (8.50) and is not open to the Wide Area Network (Internet) access. The Personal Server Security Application (8.20) generates a client and server security key pair (7.720). The Personal Server Security Client Application downloads the client security key and certificate (7.730). The Personal Server Security Application registers the Personal Server Owner's mobile device and associates the key pair with the Personal Server Owner's Mobile Device (7.740). The Personal Server Security Client Application disconnects (7.750) and configures to communicate with Personal Server Security Application securely using the client key and certificate using asymmetric encryption mechanism.

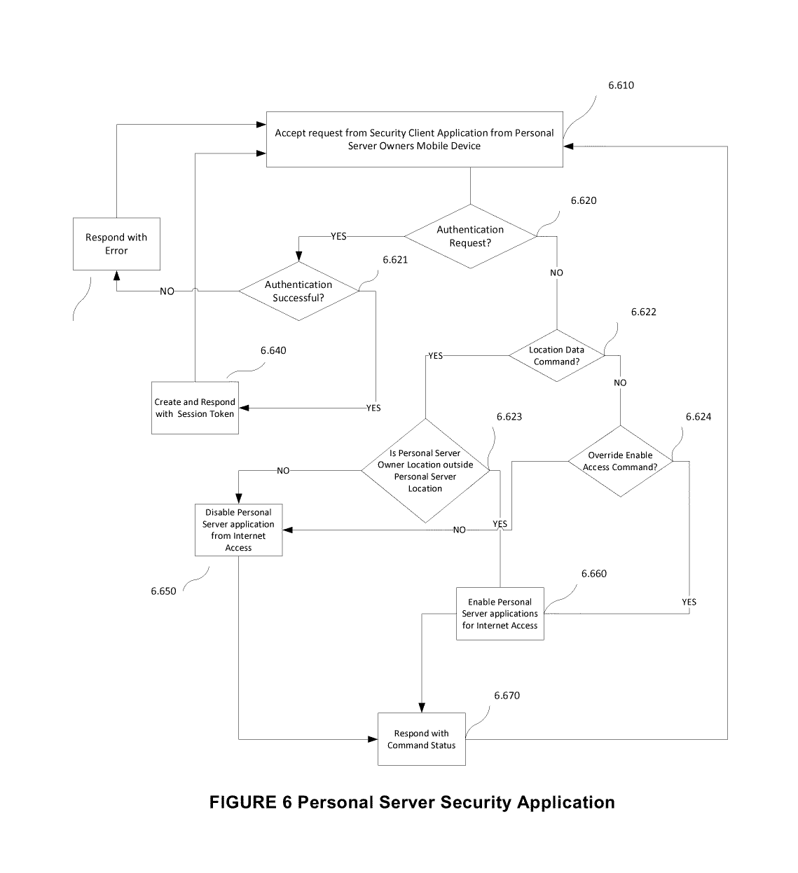

Personal Server Security Application (8.20) runs on the Personal Server (8.10) and listens for requests from the Personal Server Security Client Application (8.80). FIG. 6 depicts the flow chart for the Personal Server Security Application. The Personal Server Security Application accepts request (6.610) from the Personal Server Security Client Application from Personal Server Owner's Mobile Device (8.20). If the request is an authentication request and the authentication is successful (6.621), then the Personal Server Security Application creates a session token and responds with the session token to the Personal Server Security Client Application running on Personal Server Owner's Mobile Device. If the authentication is unsuccessful, then an error response (6.630) is provided to the Personal Server Security Client Application. If the request received is Location data command (6.622), and then check if the location data is outside the Personal Server Owner's home or office location of Personal Server (6.623). If the location data is outside the home or office location of Personal Server, then enable Personal Server applications for access from Wide Area Network (Internet) (6.660). If the location data indicates it is in the vicinity of Personal Server Owner's home or location of Personal Server then disable Personal Server Applications from Wide Area Network (Internet) access (6.650). The next step in the process is to respond with the command status (6.670) and continue listening for next request. If the request is Override Enable Access command (6.624), and the request is to override enable access command, then enable Personal Server Application for access from Wide Area Network (Internet) (6.660), or else disable Personal Server Application from Wide Area Network (Internet) access (6.650). The next step in the process is to respond with the command status (6.670) and continue listening (6.610) to the next request from Personal Server Security Client Application from Personal Server owner's Mobile Device (1.130). It may be noted that in addition to access enablement and disablement, location data can included additional commands to control the Personal Server security application that can offer other personalized location based services to the Personal Server owner or users authorized by the Personal Server owner.

### Security Client Application—Automatic Update Mode

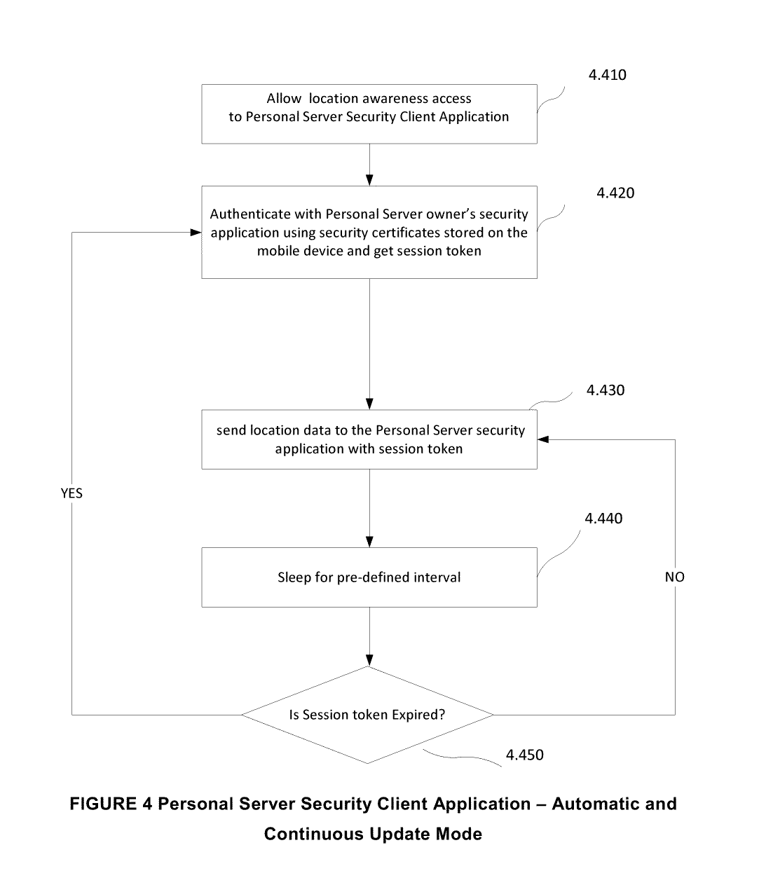

Personal Server Security Client Application (8.80) runs on the Personal Server Owner's Mobile Device (8.30) such as a smart phone, tablet, laptop or similar computing devices that are portable and can be carried by the Personal Server Owner while away from home or office environment. The Personal Server Security Client Application (8.80) can run in automatic update mode or on-demand manual override mode. FIG. 4 depicts the flow chart of the Personal Server Security Client Application when running in automatic update mode.

The Personal Server Client Security Application (8.80) is setup using the flow chart as described in FIG. 7. Once setup all communication between the Personal Server Client Security Application and the Personal Server (8.10) will use the security key and certificate to encrypt and authenticate to Personal Server Security Application. The Personal Server Client Security Application is enabled (4.410) for location data, before authenticating with the Personal Server Security Application (4.420). A session token is created by Personal Server Security Application (8.20) that is used to send the location data to Personal Server Security Application (4.430) at pre-defined interval (4.440). Personal Server Security Application will enable or disable access to Personal Server applications from Wide Area Network (Internet) based on the location data of the Personal Server Owner's Mobile Device (8.30). If the session token is expired (4.450), the mobile device will re-authenticate to create a new session token.

### Security Client Application—Manual Override Mode

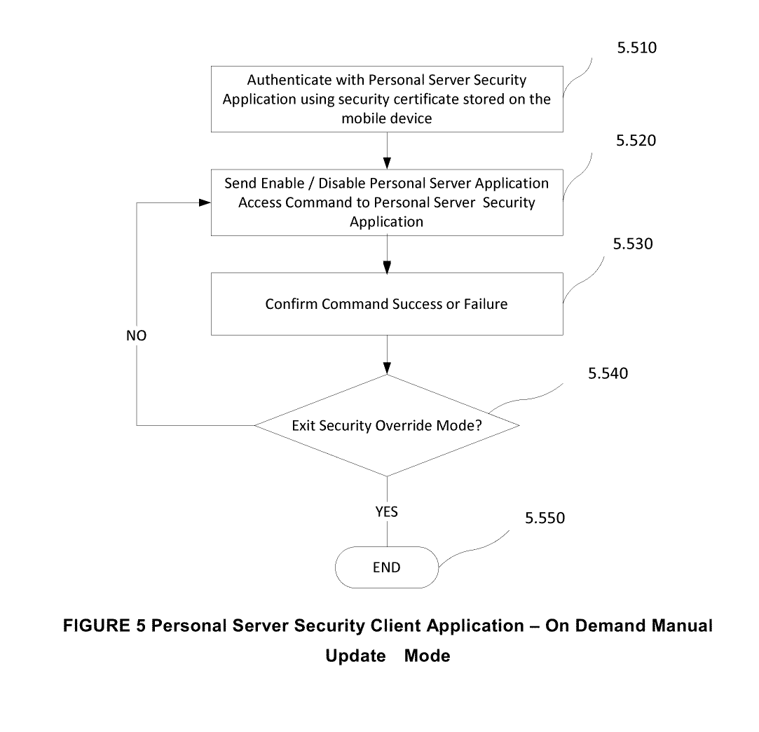

Personal Server Security Client Application (8.80) also provides a manual override mode where the Personal Server Owner can manually enable or disable access to Personal Server Applications from Wide Area Network (internet) by sending specific commands to enable or disable irrespective of the location of the Personal Server Owner's Mobile device (8.30) location. FIG. 5 depicts the flow chart for Personal Server Security Client Application's manual override mode where the Personal Server Owner can send a command from the Personal Server Owners Mobile Device (8.30) for Personal Server Security Application to allow or disallow Wide Area Network (Internet) access manually. The first step to send the command manually is to authenticate with Personal Server using security certificate stored on the mobile device (5.510). Once authenticated a session token is returned to the Personal Server Owner's Mobile Device (8.30). The session token is used for subsequent communication to the Personal Server Security Application. The Personal Server Security Client Application sends Enable or Disable command (5.520) to the Personal Server Security Application. A success or failure is returned from Personal Server Security Application. On success the Personal Server owner can exit (5.550) from the Personal Server Security Client mobile override mode or may choose to send another command (5.520). On command failure the Personal Server Owner can exit from the Personal Server Security Client Mobile override mode (5.550) or choose to send another command (5.520).

What has been described and illustrated herein is a preferred embodiment of the invention along with some of its variations. The terms, descriptions and FIGS. used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

### Alternative Embodiments of Invention

Alternative embodiment of this invention could include scheduled control of the security application. The Personal Server Owner can set schedules enabling and disabling of access of Personal Server applications that can override the location specific control as outlined in this invention.

Another embodiment of this invention could involve multiple Mobile devices owned by the Personal Server where the Personal Server may be accessible to all the Mobile Devices or Mobile Devices belonging to a group of users specifically authorized by the Personal Server Owner. In such scenario the Mobile Device of additional users' needs to be configured and setup by sharing the Personal Server Security Client Key and Certificate (8.100) as authorized by the Personal Server Owner.

Another embodiment of this invention may include multiple Personal Servers in the system each owned by individual owners within a premise and each individually addressable and controlled by their respective owners.

### DETAILED DESCRIPTION OF THE INVENTION

### A. Overview

Turning now descriptively to the drawings the figures including FIG. 8 that illustrates the system, its main elements and sub-elements of this invention. The system comprises of Personal Server (8.10), Personal Server Security Application (8.20), Personal Server Owner's Mobile Device (8.30), Network Router (8.40), Local Area Network (8.50), External IP Address (8.60), Internal IP Address (8.70), Security Client Application (8.80), Personal Server Applications (8.90), Security Client Key And Certificate (8.100), Personal Server Security Application Key (8.110), Personal Server Operating System (8.120), Mobile Device Operating System (8.130), Wide Area Network (internet) (8.140), and Domain Name Service (8.150).

### B. Personal Server (8.10)

A personal server (8.10) is a minicomputer that serves a person or a small group of persons authorized by the personal serve owner. It is typically used in a home residential environment or a location owned or assigned to the person or group of person in a home or office location. It is runs 24/7 and can provide application services to its owner when the owner is at his residence via Local Area Network (8.50) or away from his residence via Wide Area Network (Internet) (8.140).

Personal Server comprises of a computer processor, memory, mass storage device, network interface and optional input and output ports. It stores the operating system code in the storage device and loads the operating system into memory that controls the hardware and software running on the Personal Server. Personal Server has a set of basic applications and additional custom applications can be installed or downloaded over the network. Personal Server can use asymmetric or symmetric cryptographic software to securely store and transmit user data and all communication between Personal Server and connecting devices.

### C. Personal Server Security Application (8.20)

Personal Server security application is a software application that runs on the Personal Server. This application validates security certificates that are installed on the client device for secure access. The application accepts commands to enable and disable access to Personal Server Applications (8.90).

Personal Server Security Application (8.20) is a software application that runs on Personal Server (8.10) and manages the security aspects of this invention in conjunction with the Personal Server Security Client Application (8.80) running on Personal Server Owner's Mobile (8.30) device. Personal Server Security Application (8.20) uses asymmetric cryptography to authenticate and secure all requests to the Personal Server Security Application (8.20)

Personal Server Security Application (8.20) is a software application that would consist of multiple modules to handle authentication and commands to provide the security functions as described in this invention. FIG. 6 depicts the flow chart of for the key software programming steps for Personal Server Security Application (8.20). Additional functions to provide additional location based services to the personal server owner based on the location data can be provided using additional modules similar to the security function described in this invention.

### D. Personal Server Owner's Mobile Device (8.30)

Personal Server Owner's Mobile Device (8.30) is a mobile device—such as smart phones, that is carried by the owner of the Personal Server. This mobile device has the ability to connect to the Personal Server via the Wide Area Network (Internet) (8.140) and Local Area Network (8.50). The Personal Server Owner's Mobile Device (8.30) has the capability to determine the location of the mobile device and hence the location of the Personal Server Owner at any given time. The location data can be communicated to the Personal Server via the network.

Personal Server Owner's Mobile Device (8.30) is a personal computing device that is portable and can be carried easily by the Personal Server Owner outside the home or office location.

The Personal Server Owner's Mobile Device (8.30) may be a smart phone, a tablet computing device, a laptop computer that has the capability to get the current location data of the device.

### E. Network Router (8.40)

A Network Router (8.40) is a device that sits behind the home or office Wide Area Network (Internet) (8.140) service provider's Internet modem (8.60). Network Router can also be used as a firewall and has the ability to block or allow network traffic to computing devices inside a home or office running a Local Area Network. All traffic from and to Personal Server passes through the Network Router (8.40). The Network Router (8.40) also provides wireless or wired network access to mobile devices inside the home or office network.

### F. Local Area Network (8.50)

Local Area Network (8.50) is the private trusted network in home or office where computing devices are connected and interact with each other. Traffic from other Local Area Network (8.50) or Wide Area Network (Internet) (8.140) needs to go via Network Router (8.40) to reach the Personal Server (8.10). Local Area Network (8.50) uses a private set of IP (Internet Protocol) addresses. The Personal Server is connected to the Local Area Network (8.50) through its network interface. Other client computer devices of the Personal Server Owner also share the same Local Area Network (8.40) when interacting with the Personal Server in the home or office environment.

A home or office location may have multiple Local Area Networks (8.50) that may be managed by the same network router. Multiple Local Area Networks provides additional isolation and control on the Local Area Network (8.50). This invention relates to securing a Personal Server from Wide Area Network (Internet) (8.140) in relation to the more secure Local Area Network (8.50) at home or office environment.

Another variation of this invention can apply to two separate network domains that differ in network threat classification for example two separate network environment that can be located uniquely via the location services of the Personal Server Owner's mobile device within a company network or a home network can be replaced for Wide Area Network (Internet) (8.140) and Local Area Network (8.50) references in this invention.

### G. External IP Address (8.60)

A typical home internet access has a unique internet address called External IP Address (8.60) that is assigned by the Internet Service Provider through which traffic from Wide Area Network (Internet) (8.140) can reach the home or office network where the Personal Server is connected. This address may be dynamic or static based on the service subscribed by the Personal Server Owner. Network Router (8.40) can be configured to pass traffic with destination to External IP address (8.60) and a specific port to be forwarded to the Personal Server. This enables the Personal Server Owner to access the Personal Server from outside the home or office environment.

A domain name and host name can also be associated with the External IP address (8.60). Network traffic destined to a domain name associated with the External IP address (8.60) and a specific port will resolve to Personal Server Application listening on that port, if the Network Router (8.40) is configured to forward such a request to Personal Server. Multiple domain names and host names can also be assigned to the External IP address (8.60) that can resolve to individual Personal Server Applications. This enables accessing different Personal Server Applications with its own host and domain name. The domain name to External IP Address (8.60) mapping is made possible through the Domain Name Service (8.150). Domain Name Service is a registry of the association of the host and domain name with an External IP Address (8.60). The Domain Name Service ensures the Domain Name System Servers (DNS Servers) on the Internet are updated with this association. If the External IP Address (8.60) is a dynamic address that changes over time, all modern Network Router (8.40) has the capability to update the External IP Address (8.60) for a host and domain with the Domain Name Service (8.150).

A home or office network location could have multiple external IP addresses that can be connected to multiple routers managing multiple Local Area Networks. A Personal Server can be connected within each Local Area Network. Another variation of the network topology is Multiple Personal Server can be connected to the same network with one of the Personal Server acting as the master and forwarding request to other slave Personal Server on the network. This way a single external IP Address can be used to host multiple Personal Servers.

### H. Internal IP Address (8.70)

An Internal IP address (8.70) is the network addressed assigned to a computing device within the home or office network managed by the Network Router (8.70). A Personal Server is assigned an Internal IP address (8.70). The Internal IP address (8.70) can only be directly resolved within the home or office network. The Internal IP address (8.70) can also be associated with a hostname. Any request coming from outside the home or office network uses the External IP Address (8.60) or its associated host and domain name. The request is then forwarded by the Network Router (8.40) to the Personal Server based on the forwarding rules that apply to the Personal Server.

The Internal IP address (8.70) assigned to the Personal Server could be 747 dynamic or static based on the Personal Server configuration. Static internal IP address is preferred as the dynamic internal IP address can change. This would involve re-configuration on the Network Router to forward Wide Area Network (Internet) (8.140) requests to the Personal Server. To avoid the reconfiguration the Personal Server is assigned a static IP address.

### I. Personal Server Security Client Application (8.80)

Personal Server Security Client Application (8.80) is an application that runs on the Personal Server Owner's Mobile device (8.30) and communicates with the secured Personal Server Security Application (8.20) running on the Personal Server. Personal Server Security Client Application (8.80) and the Personal Server Security Application (8.20) use asymmetric cryptography to ensure the communication between the client and server is secured and authenticated. The security client application uses the installed key to encrypt request that is sent to the Personal Server and decrypt the responses from the Personal Server. Personal Server Security Client Application (8.80) uses a pre-defined port to communicate to the Personal Server Security Application (8.20). This port is separate from the Personal Server Application ports. The port used for Personal Server Security Client Application (8.80) needs to be configured on the Network Router (8.40) to forward request to the Internal IP address (8.70) and a pre-defined port on the Personal Server.

The security client application can either be a native application or an internet browser based application. In either case the security client key and certificate will have to be installed during the setup process. The setup process is done using the Local Area Network (8.50) only. It also requires and Administrator ID and password for the Personal Server. In case of browser based application the security client key and certificate will need to be stored in the browser key vault.

### J. Personal Server Applications (8.90)

Personal Server Applications (8.90) are software programs that run on the Personal Server (8.10) and provide a number of personal data and automation services to the owner of the Personal Server including support for location based services for the personal server owner. These applications are accessed through a pre-defined port for example web applications are accessed by port 80 and port 443, mail server application is accessed by port 25 and so on. Personal Server (8.10) may come with additional controller software that can help configure the Personal Server Applications (8.90). Personal Server Applications can be installed or updated using Personal Server controller application or Personal Server Operating System (8.120).

Personal Server Applications (8.90) are one or more applications that are available in the software distribution on Personal Server or custom applications that can be downloaded or installed separately. Each Personal Server Application (8.90) provides a specific function to the Personal Server Owner.

Personal Server Applications (8.90) can be part of the Personal Server Operating System. The Personal Server Application may be a web application that has a server component that runs on the Personal Server which can be accessed using a general purpose internet browser using HTTP or HTTPS protocol or it may offer a native client application that runs on the laptop, tablet, smart phone or desktop client computer that may use standard or proprietary connection protocols.

### K. Security Client Key And Certificate (8.100)

The security Client Key and Certificate (8.100) is the Personal Server Security Client key part of the asymmetric key cryptography key pair that is used to encrypt and decrypt requests originating from the Personal Server Security Client Application (8.80) in the context of this invention. The Security Client Certificate is used to authenticate the request by the Personal Server Security Application (8.20). The Security Client Key and Certificate is downloaded to the mobile device securely within the home or office network during the initial setup and configuration of the Personal Server Security Client Application (8.80). All communication from the Personal Server Security Client Application (8.80) is encrypted with this key. The resulting data can only be decrypted by the Personal Server Security Application (8.90) that holds the other part of the asymmetric key cryptography pair.

The Security Client Key and Certificate (8.100) may use various forms of asymmetric cryptography technologies.

### L. Personal Server Security Application Key (8.110)

Personal Server Security Application Key (8.110) is the Personal Server Security Application part of the asymmetric key cryptography key pair that is stored on the Personal Server (8.10). All communication data originating from the Personal Server Security Client Application (8.80) will require this key to decrypt. This ensures the data is obtained by the Personal Server Security application securely. All communication data originating from The Personal Server Security Application (8.90) uses this key to encrypt. The encrypted message can only be decrypted by the Personal Server Security Client Application (8.80) running on the Personal Server Owner's Mobile Device (8.30).

The Personal Server Security Application Key may use various forms of asymmetric cryptographic technologies.

### M. Personal Server Operating System (8.120)

Personal Server Operating System (8.120) is the software that controls the Personal Server hardware and software components including all Personal Server Applications. Personal Server Operating System provides security, memory management, power management, network protocol support, storage management functions amongst other core functions to run the Personal Server.

Personal Server may run various kinds of operating system such as Linux, UNIX and others that is customized to consume low power and includes security features customized for Personal Server applications.

### N. Mobile Device Operating System (8.130)

Mobile Device Operating System (8.130) is the software that controls the Mobile Device and mobile applications installed on the mobile device. Mobile Device Operating System (8.130) controls the Mobile Device hardware and mobile applications.

Mobile Device may run various kinds of operative system depending on the Mobile Device. Some popular Mobile Device Operating Systems are Apple iOS, Google Android, Microsoft Windows and Linux. The Mobile Device Operating Systems are not limited to this list.

O. Wide Area Network (internet) (8.140)

Wide Area Network (Internet) (8.140) is the network of computing devices and network resources connected to the Wide Area Network (Internet). Wide Area Network is geographically dispersed telecommunications network that can span the globe in a different city, state or country. Wide Area Network (Internet) is the network of computers connected and directly addressable computers by other computers on the Internet. The home or office network is connected to the Network Router (8.40) that is connected to the Wide Area Network (8.140) through the Internet Modem (8.60) enabling the home or office network to connect to the Wide Area Network (8.140) or Internet.

This invention relates to enhancing security of the Personal Server (8.10) from less trusted Wide Area Network (Internet) (8.140) in relation to more trusted Local Area Network (8.50) at home or office environment. Another variation of this invention can apply to two separate network domains that differ in network security classification for example two separate network environment that can be located uniquely via the location services of the Personal Server Owner's mobile device within a company network or a home network can be replaced for Wide Area Network (Internet) and Local Area Network (8.50) references in this invention.

The Wide Area Network (Internet) (8.20) connection to a home or office location is assigned an external IP address (8.60). Accessing the home or office network away from the home or office requires the use of this external IP address (8.60). To make the access easier to humans a hostname and domain name can be associated with the external IP address.

### P. Domain Name Service (8.150)

A Domain Name Service (8.150) facilitates the use of a host name and domain name when accessing the Personal Server (8.10). The hostname and domain name is registered with the Domain Name Service along with the associated external IP address (8.60) that is used to connect to the Personal Server (8.10). This association is done by registering the hostname and domain name to a Domain Name Service (8.150). The Domain Name Service (8.140) broadcasts this association to all the Domain Name System Servers (DNS Servers) in the Wide Area Network (Internet) (8.140) so that all client computers connected to the Wide Area Network (Internet) is able to connect to the Personal Server (8.10) using the hostname and domain name automatically. The domain name service is a third party service the Personal Server owner subscribes to be able to access the Personal Server (8.10) without remembering the External IP Address (8.60). The Domain Name Service (8.150) is also useful when the External IP Address (8.60) is assigned by the Internet Service Provider as a dynamic address. All modern Network Routers (8.40) have the capability to detect a change in the External IP Address (8.60) and communicate the new External IP Address (8.60) to the Domain Name Service (8.150) automatically. This greatly facilitates the use of the Personal Server by the Personal Server owner when accessing the Personal Server (8.10) away from home or office location. While the use of host name and domain name is not required for all Personal Server application the use of a host name and domain name enables ease of using the Personal Server Applications (8.90) from the Personal Server Owner's Mobile Devices (8.30).

Other forms of standard lookup may be employed, where the Personal Server Owner's Mobile Devices (8.30) can bypass the Domain Name System Servers by associating the name to external IP address mapping in a local file or configuration in the Personal Server Owner's Mobile Devices (8.30). However some Personal Server Applications (8.90) may require the use of a hostname or domain name to function correctly. In other embodiment of this invention other technologies and standards can be used for mapping a hostname and domain name to the external IP address (8.60) of the target Personal Server without a Domain Name Service (8.150).

### Q. Connections of Main Elements and Sub-Elements of Invention

FIG. 8 shows the connections between the main elements and sub elements. The following description relates to FIG. 8.

The Personal Server (8.10) is connected to the Local Area Network (8.50). Personal Server (8.10) contains the sub elements of Processor (8.11), Memory (8.12), Bus (8.13), Network Interface (8.14), Mass Storage (8.15), Input/Output Ports (8.16). The Personal Server runs the Personal Operating System Software (8.120), Personal Server Applications (8.90), and also Personal Server Security Application (8.20) related with this invention. Personal Server Security Application Key (8.110) is stored on the Personal Server.

Personal Server (8.10) is assigned an internal IP address (8.70). Personal Server (8.10) is also addressable via the external IP address (8.60) at specific pre-defined port via the configuration on the Network Router (8.40) from the Wide Area Network (8.40).

Personal Server Owner's Mobile Device (8.30) can connect to the Personal Server (8.10) via the Wide Area Network (Internet) (8.140) using a domain name that maps to the external IP Address (8.60) or via the internal IP Address when the Personal Server Owner's Mobile device is within the vicinity and range of the Local Area Network (8.50).

The main element Personal Server Owner's Mobile Device (8.30) consists of Bus (8.32) that interconnects all the sub elements. The sub elements are a Processor (8.31), Memory (8.33), Network Interface (8.34), Global Positioning System (GPS) (8.36), Display, Touch Input/Keyboard and Pointing Devices (8.37). The Mobile Device (8.30) runs a Mobile Operating System (8.130) that manages the hardware sub elements of the Mobile Device (8.30) and Mobile Applications including the Personal Server Security Client Application (8.80) specific to this invention. Personal Server Security Client Key and Certificate (8.100) is downloaded and installed on the Personal Server Owner's Mobile Device (8.30) during the onetime setup when configuring the Security Client Application.

### INDEX OF ELEMENTS

The main elements and sub-elements of the system for this invention and their inter-connections are shown in FIG. 8. The index of elements and sub-elements as referred to in FIG. 8 are listed below:

8.10: Personal Server
8.11: Processor
8.12: Memory
8.13: Bus
8.14: Network Interface
8.15: Mass Storage
8.16: Input/Output Ports
8.17: Input/Output Controller

8.20: Personal Server Security Application

8.30: Personal Server Owner's Mobile Device
8.31: Processor
8.32: Bus
8.33: Memory
8.34: Network Interface
8.35: Storage
8.36: Global Positioning System (GPS)
8.37: Display/Touch Input/Keyboard
8.38: Input/Output Controller

8.40: Network Router

8.50: Local Area Network

8.60: Internet Modem/External IP Address

8.70: Internal IP Address

8.80: Security Client Application

8.90: Personal Server Applications

8.100: Security Client Key and Certificate

8.110: Personal Server Security Application Key

8.120: Personal Server Operating System

8.130: Mobile Device Operating System

8.140: Wide Area Network (internet)

8.150: Domain Name Service

What is claimed is:

1. A system to enhance personal server security using geo location data of the personal server owner; comprising of one or more mobile client computer, security client application, security client key and certificate, wide area network, domain name service, internet modem with external IP address, one or more personal server computer, internal IP address, network router, local area network, personal server security application, personal server security application key and one or more personal server application.

2. A system as claimed in 1, wherein the mobile client computer is owned by the same user who owns the personal server or users authorized by the owner of the personal server.

3. A system as claimed in 1, wherein the personal server computer is housed at the premises of the personal server owner's home or office and is connected to the local area network at premises and also to the wide area network that provides access to personal server when personal server owner is outside the premises.

4. A system as claimed in 1, wherein the mobile client computer is capable of connecting to the personal server computer system via the wide area network or via the local area network.

5. A system as claimed in 1, wherein the personal server that contains processor, memory, one or more input/output (I/O) controller, one or more mass storage device for storing program code instructions for the personal server operating system, applications, system and personal data; one or more networking interface, a system bus that connects the various components and facilitates data transfer and control;
one or more personal server software application to manage and configure personal server for backup, restore, secure data exchange, mail server, web server, data sharing, authorized peer server sharing, authentication and authorization, creation of scheduled tasks, monitor and respond to external device events and notifications.

6. A system as claimed in 1, wherein the system component personal server connects to the local area network and the wide area network also called internet through its network interface or wireless network interface.

7. A system as claimed in 1, wherein the mobile client computer contains processor, memory, one or more input and output controller, one or more mass storage device for storing program code instructions for the mobile client computer operating system, one or more network interface, a system bus that connects the various components and facilitates data transfer and control; a global positioning system to obtain location data of the mobile client computer or capability to determine location of the mobile client computer through other means, a display device, one or more input device for interfacing with the mobile client computer.

8. A system as claimed in 1, wherein a domain name service capable routing requests by resolving the external name and domain name of the personal server to the external IP address in the wide area network that relates to the premises where personal server is physically located and that is routable to the internal IP address of the personal server using the network router.

9. A system as claimed in 1, wherein the network router is capable of routing requests to the personal server by resolving the internal IP address or local name of the personal server.

10. A method for the personal server security client application running on the mobile client computer for sending location data and associated commands automatically and continuously to the personal server by authenticating to the personal server using the security certificate stored on the mobile client device to prove the authenticity of the mobile client computer.

11. A method as claimed in 10, wherein additional commands can be included with the location data sent to the personal server security application to control additional aspects of the personal server security application and personal server application to provide additional personalized location based services to the personal server owner.

12. A method for the personal server security client application running on the mobile client computer for sending location data and associated commands on demand to the personal server by authenticating to the personal server using the security certificate stored on the mobile client device to prove the authenticity of the mobile client computer.

13. A method for the personal server security application running on the personal server computer to accept authentication request from the mobile client computer and to process associated command to enable and disable access from wide area network or accept manual override command from the mobile client computer to selectively enable and disable access to personal server application from wide area network.

14. A method as claimed in 13, wherein additional commands received can be used to control additional aspects of the personal server security application and personal server applications to provide additional location based services to the personal server owner.

15. A method to setup and configure the personal server security application and also the personal server security client application by generating client and server security key pair and downloading to the security client application which is used to authenticate to the personal server security application when sending location data and associated commands to the personal server security application.
